(19) United States
(12) Patent Application Publication
(10) Pub. No.: US 2005/0251684 A1
(43) Pub. Date: Nov. 10, 2005

(54) Storage control system and storage control method

(75) Inventors: Yoshio Mitsuoka, Odawara-shi (JP); Hiroshi Kuwabara, Naka-gun (JP)

Correspondence Address: REED SMITH LLP, Suite 1400, 3110 Fairview Park Drive, Falls Church, VA, 22042, US

(73) Assignee: Hitachi, Ltd.

(21) Appl. No.: 11/104,492

(22) Filed: Apr. 13, 2005

Related U.S. Application Data
(63) Continuation-in-part of application No. 10/768,147, filed on Feb. 2, 2004.
(63) Continuation-in-part of application No. 11/076,868, filed on Mar. 11, 2005.

(51) Int. Cl. G06F 3/023

(52) U.S. Cl. 713/182

(57) ABSTRACT

Accesses are controlled which are received on the basis of the iSCSI protocol. A control apparatus which receives an iSCSI name and a log-in request of a host apparatus from the host apparatus via one or a plurality of communication networks, one or more storage apparatus which can be an access destination of the host apparatus, and a storage resource in which one or a plurality of iSCSI names are stored beforehand are provided. The control apparatus refers to the storage resource to judge whether or not the received iSCSI name matches with any of the pre-registered one or a plurality of iSCSI names. When a positive judgment result is obtained, the control apparatus permits a log-in to the host apparatus, and, when a negative judgment result is obtained, does not permit a log-in to the host apparatus in accordance with the received log-in request.

### BACKGROUND OF THE INVENTION

1. Field of the Invention

The present invention is related to a technique for controlling an access which is received via a communication network from an external apparatus, concretely speaking, for instance, directed to a storage control system for controlling an access in accordance with the iSCSI protocol, received via the communication network.

2. Description of the Invention

For instance, such a fibre channel connection storage control apparatus has already been known from, for example, JP-A-10-333839, and this fibre channel connection storage control apparatus controls accesses received form a plurality of upper grade apparatus via a fibre channel.

### SUMMARY OF THE INVENTION

On the other hand, in IP-SAN (Internet Protocol-Storage Area Network), it is known that communication operations are carried out based upon such a communication protocol called as “iSCSI (symbol “SCSI” is abbreviated as “Small Computer System Interface)”. The communication techniques operated based upon the iSCSI protocol own one major aspect, namely, how to prevent illegal accesses in order to improve security.

However, the access control technique made based upon the fibre channel, as described in above-described Patent Document 1, cannot be merely applied to the technique used to control the accesses based upon the iSCSI protocol. This reason is given as follows: That is, an access which is received via a fibre channel by a storage control apparatus must be equal to such an access which is issued from a host apparatus connected to the same communication network. However, the first-mentioned access is not such an access which is issued from an undefined node connected to another communication network as explained in the access made based upon the iSCSI protocol. Concretely speaking, in accordance with the iSCSI protocol, there are some cases that, for instance, a storage control apparatus connected to a certain LAN (Local Area Network) may accept an access issued from an undefined information processing terminal via both another LAN and the Internet to which the last-mentioned LAN is connected.

As previously explained, in the communication technique established based upon the iSCSI protocol, one major aspect thereof is conceivable. That is, high security may be provided by executing such a way that how the access control operation is carried out. Also, this sort of major aspect may exist in such a system that accesses are accepted via either one or a plurality of other communication networks, but not via the same communication network, while this major aspect is not limited only to the above-explained iSCSI protocol.

As a consequence, an object of the present invention is to control accesses which are received based upon the iSCSI protocol.

Other objects of the present invention may become apparent from the below-mentioned descriptions.

A storage control system, according to a first aspect of the present invention, comprises a control apparatus which receives from a host apparatus an iSCSI name and a log-in request of the host apparatus via one or plurality of communication networks, one or more storage apparatuses which can be an access destination of the host apparatus, and a storage resource in which one or plurality of iSCSI names are stored beforehand. The control apparatus refers to the storage resource, judges whether or not the received iSCSI name matches with any of the one or plurality of iSCSI names registered beforehand, permits a log-in to the host apparatus when a positive judgment result is obtained, and does not permit a log-in to the host apparatus when a negative judgment result is obtained, in accordance with the received log-in request.

The control apparatus can be one or more processors, for example. More specifically, for instance, the control apparatus can be a channel adopter, which will be described hereinafter. Therefore, a series of process operations carried out by the control apparatus may be carried out by, for example, a protocol processing unit employed in the iSCSI port which will be described hereinafter, and/or by the channel processor solely which will be described hereinafter, or in cooperation with the protocol processing unit.

An expression “communication network” implies a single communication network (for instance, either LAN or Internet) which is segmented in either a physical manner or a logical manner. Since a plurality of communication networks are connected to each other via either one sort or plural sorts of pre-selected switching apparatus, a single communication network group can be constructed. Concretely speaking, for example, either one or plural appliances which contain a storage control apparatus are connected to a first switching unit (for example, switch), so that a first communication network (for example, LAN) is constituted, to which either one or plural appliances have been connected. Similarly, either one or a plurality of first upper grade apparatus are connected to a second switching unit (for instance, switch), so that a second communication network (for example, LAN) is constituted, to which either one or a plurality of first upper grade apparatus have been connected. Then, the first switching unit is connected via a predetermined switching apparatus (for instance, gateway) to the second switching unit, so that a communication network group which contains both the first communication network and the second communication network is arranged.

In one embodiment, before receiving an access from the host apparatus to which a log-in is permitted, the control apparatus prepares a management table for controlling an access from the host apparatus, and a table ID for identifying the management table, and can relate the table ID, a host information element related to the host apparatus, and the iSCSI name of the host apparatus to each other. Further, when the control apparatus receives an access request from the host apparatus to which a log-in is permitted, the control apparatus can specify a table ID corresponding to the host information element of the host apparatus, and controls the access by using the management table identified based on the specified ID table.

Here, “the host information element” can be, for example, either one or both of an IP address and/or TCP port number. This “IP address” may be equal to such an IP address owned by a host apparatus, which has been allocated in a communication network to which the host apparatus is connected. Alternatively, this “IP address” may be equal to such a global IP address which has been allocated to a predetermined switching unit used to constitute a target communication network to which the host apparatus is connected.

In one embodiment, the control apparatus can determine a permission access type to be permitted for the host apparatus to which a log-in is permitted, relate the determined permission access type to the iSCSI name of the host apparatus on the storage resource, and relate the iSCSI name of the host apparatus to the host information element related to the host apparatus. Further, when the control apparatus receives an access request from the host apparatus to which a log-in is permitted, the control apparatus specifies an iSCSI name corresponding to the host information element of the host apparatus, specifies a permission access type corresponding to the specified iSCSI name, and judges whether or not the access type of the access request matches with the specified permission access type. When a positive judgment result is obtained, the control apparatus can execute the processing in accordance with the access request.

In one embodiment, the storage resource may be related to a sub-permission access type for each access destination of the storage apparatus which is accessed in accordance with an access request. When the positive judgment result is obtained, the control apparatus can specify the sub-permission access type corresponding to an access destination in accordance with the access request from the storage resource, judges whether or not the access type of the access request matches with the specified sub-permission access type, and, when a positive judgment result is obtained, execute the processing in accordance with the access request.

In one embodiment, the control apparatus can determine a permission access type to be permitted for the host apparatus to which a log-in is permitted, on the basis of a system-host distance between the storage control system and the host apparatus. When the control apparatus receives an access request from the host apparatus to which a log-in is permitted, the control apparatus can judge whether or not an access type of the access request relates to the permission access type, and, when a positive judgment result is obtained, execute the processing in accordance with the access request.

In one embodiment, the control apparatus can transmit a TTL to the host apparatus to which a log-in is permitted, receive a reception TTL value, which is a value expressed by the TTL received by the host apparatus, from the host apparatus, and determine the permission access type on the basis of a difference value between the value expressed by the transmitted TTL and the reception TTL value or on the reception TTL value itself.

In one embodiment, the storage resource may be related to a storage apparatus ID that the host apparatus, which is identified from one or a plurality of iSCSI names, is allowed to recognize. The control apparatus can specify a storage apparatus ID corresponding to the iSCSI name of the host apparatus to which a log-in is permitted by referring to the storage resource, and notify the host apparatus to which a log-in is permitted of the specified storage apparatus ID.

The storage apparatus ID is to be able to uniquely identify a storage apparatus (may be physical or logical). For example, if the storage apparatus is a LU (logical unit), the storage apparatus ID for it can be a LUN (logical unit number).

A storage control method in accordance with a second aspect of the present invention is a method which can be realized by a storage control system comprising one or more storage apparatuses which can be an access destination of a host apparatus, wherein an iSCSI name and a log-in request of the host apparatus are received from the host via one or plurality of communication networks, a storage resource in which one or plurality of iSCSI names are stored beforehand is referred, it is judged whether or not the received iSCSI name relates to the one or any one of the iSCSI names registered beforehand, and when a positive judgment result is obtained, a log-in to the host apparatus is permitted according to the received log-in request.

### BRIEF DESCRIPTION OF THE DRAWINGS

FIG. 1 schematically indicates an entire arrangement of an access control system according to an embodiment of the present invention;

FIG. 2 is a schematic block diagram for showing a hardware structure of a storage control system 3 employed in the access control system of FIG. 1;

FIG. 3 illustratively shows a structure of a data table group 51 stored in a shared memory 47 of the storage control system 3;

FIG. 4 illustratively indicates another structure of the data table group 51 stored in the shared memory 47;

FIG. 5 illustratively represents a protocol structure in a communication operation related to the iSCSI protocol;

FIG. 6 illustratively indicates a structure of commands which are transmitted/received in the communication operation related to the iSCSI protocol;

FIG. 7 is a flow chart for describing a process operation executed in the storage control system 3 as to access operation from a log-in request source host;

FIG. 8 shows an example of a process flow of access control after the log-in is performed in the process of FIG. 7;

FIG. 9(A) shows an example of a structure of the first table in the first modified example of the first embodiment of the present invention. FIG. 9(B) shows an example of structures of the second and third tables in the second modified example of the first embodiment of the present invention. FIG. 9(C) shows that plural types of channel adapters are mixed in the storage control system according to the second modified example. FIG. 9(D) shows an example of a structure of the host management table used in the plural types of channel adapters;

FIG. 10(A) is a block diagram for explaining the process operations carried out in the third modified example of the first embodiment of the present invention. FIG. 10(B) is a figure showing an example of flow of the process operations carried out by the channel processor 40 in the third modified example; and

FIG. 11(A) shows an example of a structure of the transmission TTL management table which can be prepared in the third modified example of the first embodiment of the present invention. FIG. 11(B) shows an example of a structure of the permission access type setting rule table which can be prepared in the third modified example. FIG. 11(C) shows an example of a structure of the LUN security table which can be prepared in the fourth modified example of the first embodiment of the present invention.

### DESCRIPTION OF THE PREFERED EMBODIMENTS

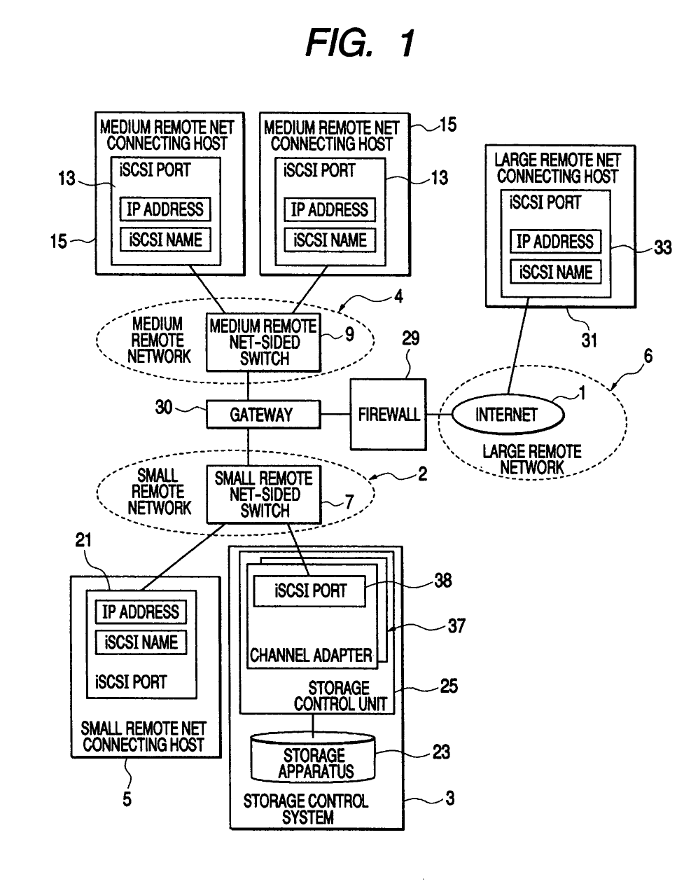

FIG. 1 schematically shows an entire arrangement of an access control system according to an embodiment of the present invention.

In this access control system, a plurality of communication networks are mutually connected to each other so as to constitute a single network group. The plurality of communication networks contain a communication network 2, 4 and 6. Concretely speaking, for instance, the plural communication networks contain a “small remote network” 2, a “medium remote network” 4, and a “large remote network” 6. In the small remote network 2, the distance from a network to which the storage control system is connected to (referred to as “internetwork distance” hereinbelow) is zero, or a small degree. In the medium remote network 4, an internetwork distance is a medium degree. In the large remote network 6, an internetwork distance is a large degree.

In this connection, an expression “internetwork distance is zero, or small degree” implies the communication network 2 itself to which the storage control system 3 is connected, or implies such a switching device that a sort of physical, or logical intervening device interposed between this communication network 2 and a connection destination network thereof is the same as a small remote net-sided switch 7 (will be discussed later). Alternatively, this expression implies that a total number of interposed switching devices is small (for example, one piece of interposed switching device).

Also, another expression “internetwork distance is medium degree” implies that, for instance, a predetermined sort of the above-explained interposed devices (for example, gateways) are present between the communication network 2 to which to which the storage control system 3 is connected and the connection destination network thereof (otherwise, total number of interposed switching devices is medium degree).

Also, another expression “internetwork distance is large degree” implies that, for example, instead of, or in addition to the above-described predetermined sort of intervening devices (for instance, gateways), another sort of the above-described intervening devices (for instance, firewalls) are located between the communication network 2 to which the storage control system 3 is connected and the connection destination network thereof (alternatively, total number of interposed switching devices is large).

The small remote network 2 is constituted by that either one or a plurality of node appliances are connected to a network constructing appliance (for example, hub) such as the small remote net-sided switch 7. To this small remote net-sided switch 7, either one or a plurality of host apparatus (will be referred to as “small remote net connecting host” hereinafter) 5, and a storage control system 3 are connected. This storage control system 3 receives an access issued from a host apparatus 5, another host apparatus 15, or another host apparatus 31.

The small remote net connecting host 5 corresponds to a computer machine such as a personal computer and a PDA (Personal Digital Assistants). The small remote net connecting host 5 is equipped with an iSCSI port 21 which is used to perform a communication operation based upon the iSCSI protocol. Since this iSCSI port 21 is connected to the small remote net-sided switch 7, the small remote net connecting host 5 can carry out the communication operation based upon the iSCSI protocol. A storage media (will be referred to as “port memory” hereinafter) such as a memory is provided with the iSCSI port 21. Both an IP address allocated to the small remote net connecting host 5 and a specific iSCSI name have been stored in this port memory.

The storage control system 3 is provided with a storage apparatus 23 and a storage control unit 25. The storage apparatus 23 contains a plurality of physical disk groups (for example, hard disk group). The storage control unit 25 controls an access to the storage apparatus 23 issued from the host apparatus 5, 15, or 31. This storage control unit 25 is equipped with a plurality of channel adaptor sets 37 which control communication operations between the own channel adaptor sets 37 and the host apparatus 5, 15, or 31. An iSCSI port 38 is mounted on each of channel adaptors contained in the channel adaptor sets 37. Since this iSCSI 38 is connected to the small remote net-sided switch 7, the storage control system 3 can carry out a communication operation based upon the iSCSI protocol.

The medium remote network 4 is constructed by that either one or a plurality of node appliances are connected to a network construction-purpose appliance (for example, hub) such as a medium remote net-sided switch 9. Either one or a plurality of host apparatus (will be referred to as “medium remote net connecting host” hereinafter) 15 are connected to the medium remote net-sided switch 9.

Similar to the small remote net connecting host 5, the medium remote net connecting host 15 corresponds to a computer machine such as a personal computer and a PDA (Personal Digital Assistants). The medium remote net connecting host 15 is also equipped with an iSCSI port 13. Since this iSCSI port 13 is connected to the medium remote net-sided switch 9, this medium remote net connecting host 15 can carry out the communication operation based upon the iSCSI protocol. A port memory is provided with the iSCSI port 13. Both an IP address allocated to the medium remote net connecting host 15 and a specific iSCSI name have been stored in this port memory.

The large remote network 6 is constructed by that either one or a plurality of node appliances are connected to the Internet 1 in a communicatable manner. Either one or a plurality of node appliances correspond to, for instance, a host apparatus (will be referred to as “large remote net connecting host” hereinafter) 31.

Similar to the small remote net connecting host 5, the large remote net connecting host 31 corresponds to a computer machine such as a personal computer and a PDA (personal Digital Assistants). The large remote net connecting host 31 is also equipped with an iSCSI port 33. Since this iSCSI port 33 is connected to the large remote net-sided switch 31, this large remote net connecting host 31 can carry out the communication operation based upon the iSCSI protocol. A port memory is provided with the iSCSI port 33. Both an IP address allocated to the large remote net connecting host 33 and a specific iSCSI name have been stored in this port memory.

The small remote net-sided switch 7 of the above-described small remote network 2 is connected to the medium remote net-sided switch 9 of the medium remote network 4 via a gateway 30 (for example, predetermined protocol converting machine for converting command made based upon iSCSI protocol and command made based upon FC protocol with each other). Also, the gateway 30 is connected via a firewall 29 to the Internet 1. As a result, the small remote network 2 is connected to both the medium remote network 4 and the large medium remote network 6. Under this environment, the storage control system 3 can be communicated with any one of the net connecting hosts 5, 15, and 31.

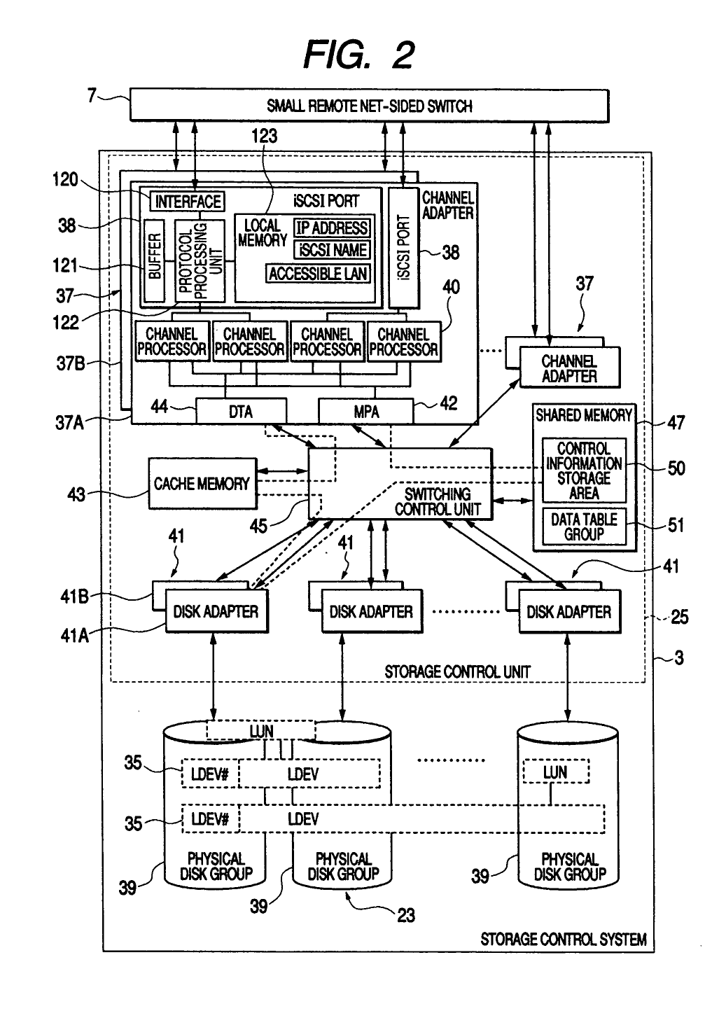

FIG. 2 is a schematic block diagram for showing a hardware structure of the storage control system 3.

The storage control system 3 corresponds to, for instance, a RAID (Redundant Array of Independent Inexpensive Disks) system. As the storage apparatus 23, one, or more sets of physical disk groups 39 are provided which have a plurality of disk type storage apparatus arranged in an array shape. Either one or a plurality of logical devices (will be abbreviated as “LDEV” hereinafter) 35 corresponding to logical storage areas have been set to physical storage areas provided by these physical disk group 39. Identification information of these LDEVs (will be referred to as “LDEV#” hereinafter) has been allocated to the respective LDEVs 35, and further, a logical unit number (will be abbreviated as “LUN” hereinafter) has been applied to each of these LDEV#, while this LUN can designate the host apparatus 5, 15, or 31.

Also, the storage control system 3 is equipped with either one or a plurality of channel adaptor sets 37, a cache memory 43, a shared memory 47, either one or a plurality of disk adaptor sets 41, and a switching control unit 45.

Each of the channel adaptor sets 37 contains a plurality (typically two sets) of channel adaptors 37A and 37B. These channel adaptors 37A and 37B own the essentially same constructions. As a result, for instance, in such a case that the host apparatus 5, 15, or 31 cannot access via one channel adaptor 37A to a predetermined LDEV, this host apparatus 5, 15, or 31 accesses via the other channel adaptor 37B to the same predetermined LDEV (this technical idea is essentially similar to disk adaptor sets 41). Since the channel adaptors 37A and 37B own the essentially same constructions, the construction of the channel adaptor 37A will now be explained as a typical channel adaptor.

The channel adaptor 37A is equipped with either one or a plurality (for example, two pieces) of iSCSI ports 38 and 38, and is connected via this iSCSI port 38 to either one or a plurality of host apparatus 5, 15, and 31 under communicatable condition. The channel adaptor 37A may be constituted by a hardware circuit, software, or a combination of the hardware circuit and the software. The channel adaptor 37A performs a data communication operation between this storage control system 3 and the host apparatus 5, 15, or 31. The iSCSI port 38 is provided with an interface 120, a buffer 121, a local memory 123, and a protocol processing unit 122. The interface 120 owns a cable port which is physically connected to the small remote net-sided switch 7. The buffer 121 corresponds to such a memory which temporarily stores thereinto data transmitted/received between the storage control system 3 and the host apparatus 5, 15, or 31. The local memory 123 is, for example, a nonvolatile memory, and stores thereinto an IP address, an iSCSI name, and a LUN to which this iSCSI port 38 can access. The protocol processing unit 122 connected via a predetermined internal bus (for example, PCI bus) to the channel processors 40 and 40 under communicatable condition. This protocol processing unit 122 executes a protocol process operation in accordance with TCP/IP, iSCSI, and SCSI protocols (will be explained later) based upon information stored in both the buffer 121 and the local memory 123. It should be understood that the function capable of executing the protocol processing operation in accordance with the above-described TCP/IP, iSCSI, and SCSI protocols may be provided with the channel processor 40 instead of the protocol processing unit 122.

Also, one piece, or more pieces of microprocessors (will be referred to as “channel processors” hereinafter) 40 are also mounted on this channel adaptor 37A, and these microprocessors 40 are connected to the respective iSCSI ports 38 under communicatable condition. Furthermore, a microprocessor adaptor (will be abbreviated as “MPA” hereinafter) 42, and a data transfer adaptor (will be abbreviated as “DTA”) 44 are mounted on the channel adaptor 37A. The microprocessor adaptor 42 is connected to the shared memory 47 under communicatable condition, whereas the data transfer adaptor 44 is connected to the cache memory 43 under communicatable condition. In such a case that the channel processor 40 transmits/receives control information (for example, message transmitted/received between processors) with respect to an external processor (concretely speaking, microprocessors provided in disk adaptors 41A and 41B, and are not shown in drawings), the control information is transmitted/received via the MPA 42. Both in the case that write data is written from the host apparatus 5, 15, or 31 into the LDEV 35, and also, in such a case that read data which has been read from the LDEV 35 is outputted from the storage control system 3 to the host apparatus 5, 15, or 31 both the write data and the read data pass through the DTA 44.

For example, each of the channel processors 40 may execute a polling operation as to the control information storage area 50 of the shared memory 47 so as to acquire the control information via the MPA 42; may read out the read data which has been stored in the cache memory 43 so as to transmit this read data to the host apparatus 5, 15, or 31; and may store such a data to be written (namely, write data) which has been received from the host apparatus 5, 15, or 31 into the cache memory 43.

The cache memory 43 corresponds to either a volatile memory or a nonvolatile memory. Into the cache memory 43, both write data and read data are temporarily stored. The write data is transferred from the channel adaptors 37A and 37B to the disk adaptors 41A and 41B of the disk adaptor set 41. The read data is transferred from the disk adaptors 41A and 41B to the channel adaptors 37A and 37B.

The shared memory 47 corresponds to a nonvolatile memory. The shared memory 47 is equipped with, for instance, the control information storage area 50 and the data table group 51. The above-described control information is stored in the control information storage area 50.

Each of the disk adaptor set 41 is provided with respect to each of the physical disk groups 39. Each of the disk adaptors 41A and 41B is provided with either one or a plurality of microprocessors (not shown). Since the process operation by this microprocessor is carried out, data is read, or written with respect to the LDEV 35 having the LDEV# corresponding to the LUN which is designated by the host apparatus, 5, 15, or 31.

The switching control unit 45 may be arranged, for example, as a high-speed bus such as an ultra high-speed crossbar switch which executes a data transfer operation by way of a high-speed switching operation. The switching control unit 45 is connected with the respective channel adaptors 37A and 37B, the respective disk adaptors 41A and 41B, the shared memory 47, and the cache memory 43 under communicatable manner. Either data or commands are transmitted/received via this switching control unit 45 among the respective channel adaptors 37A and 37B, the respective disk adaptors 41A and 41B, the shared memory 47, and the cache memory 43.

The above-described process operations describe an outline of the storage control system 3 according to this embodiment. In response to an I/O request issued from the host apparatus 5, 15, or 31, that storage control system 3 executes a process operation based upon a content of this I/O request.

Subsequently, an outline as to process flow operations of an I/O request executed in the storage control system 3 will be explained by exemplifying such a case that the host apparatus 5 issues this I/O request. In this outline explanation, the process flow operations are subdivided into such a case that the issued I/O request indicates a read request, and such a case that the issued I/O request represents a write request.

(1) In the case that the I/O request indicates the read request.

The I/O request issued from the host apparatus 5 is stored into the buffer 121 of the iSCSI port 38. The channel processor 40 reads out this stored I/O request, and judges as to whether or not data required to be read (namely, read data) in this I/O request is present in the cache memory 43.

In the case that a judgement result becomes “YES”, namely the read data is present in the cache memory 43 (namely, in case of “cache hit”), the channel processor 40 acquires the read data from the cache memory 43 via the DTA 44, and then transmits this acquired read data to the host apparatus 5 via the iSCSI port 38.

On the other hand, in such a case that the above-described judgement result becomes “NO”, namely the read data is not present in the cache memory 43 (namely, in case of “cache mis”), the channel processor 40 stores such a control information into the shared memory 47 via the MPA 42. This control information is used to instruct a microprocessor (will be referred to as “disk processor” hereinafter) of the disk adaptor 43A in such a manner that this disk processor once reads such a read data within the predetermined LDEV 35 in the cache memory 43. Since the disk processor reads this control information, the read data is read out from the predetermined LDEV 35 and is stored in the cache memory 43 by this disk processor. Thereafter, the channel processor 40 acquires this read data from the cache memory 43, and then transmits the acquired read data to the host apparatus 5.

(2) In the case that the I/O request indicates the write request.

The I/O request containing write data, which is outputted from the host apparatus 5 is stored into the buffer 121 of the iSCSI port 38. The channel processor 40 reads out this stored I/O request, and judges as to whether or not data is located in a predetermined area (will be referred to as “predetermined cache slot” hereinafter) of the cache memory 43.

In the case that a judgement result becomes “YES”, namely the data is located in the predetermined cache slot of the cache memory 43 (namely, in case of “cache hit”), the channel processor 40 overwrites the write data contained in the read I/O request with respect to the data stored in the predetermined cache slot.

On the other hand, in such a case that the above-described judgement result becomes “NO”, namely the data is not located in the predetermined cache slot (namely, in case of “cache mis”), the channel processor 40 instructs the drive control unit 107 to once read in the cache memory 43, such a data from the LDEV which is specified by the read I/O request. As a result, if data is read out from this data storage area to be stored into the predetermined cache slot by the disk adaptor 107, then the channel processor 40 overwrites the write data contained in the I/O request with respect to the data stored in the predetermined cache slot.

As explained above, when the write data has been written into the cache memory 43, a completion notification is returned from the storage control system 30 to the host apparatus 5 while it is regarded that this write request has been ended. Generally speaking, at such a time instant when the write data is written in the cache memory 43, this data is not yet reflected to the predetermined LDEV 35. Thereafter, the write data is read out from the cache memory 43 so as to be written into the predetermined LDEV by the disk processor.

The above-described process operation implies the outline of the data read/write process operations executed in the storage control system 3.

A major unit as to the access control system according to this embodiment will now be described in detail.

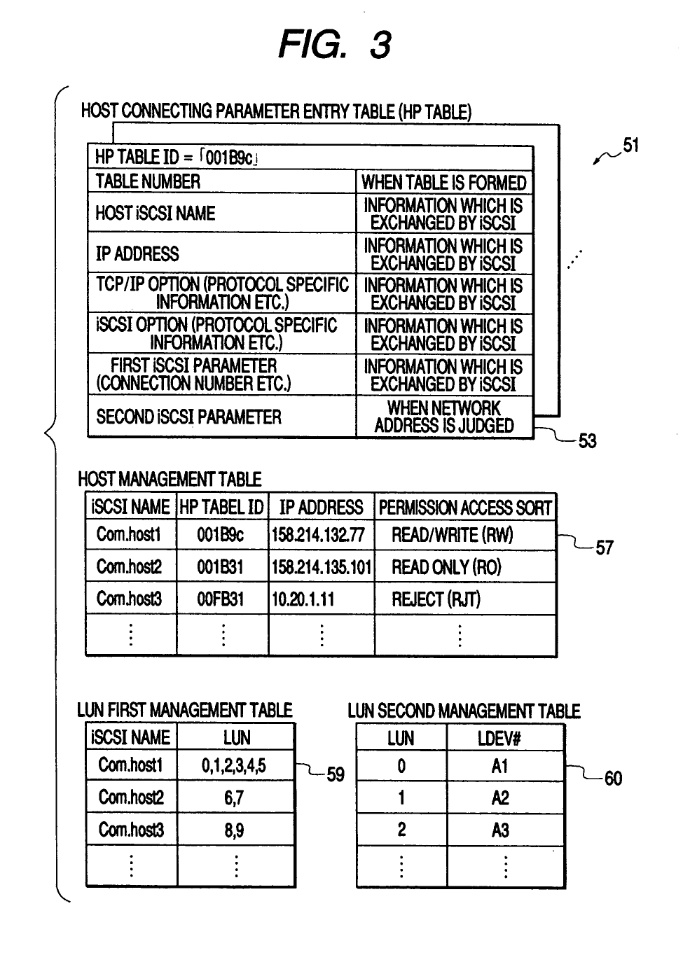

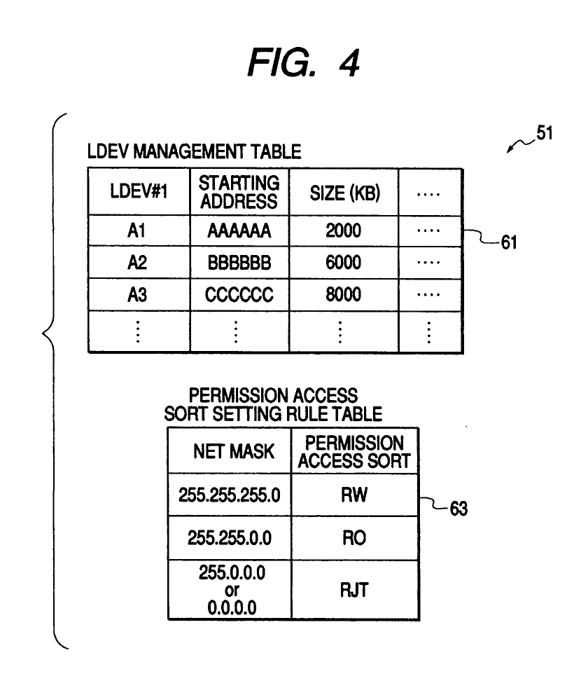

FIG. 3 and FIG. 4 illustratively show a construction of the data table group 51 which is stored in the shared memory 47.

As indicated in FIG. 3, the data table group 51 contains a host connecting parameter entry table (will be referred to an “HP table” hereinafter) 53, a host management table 57, a LUN first management table 59, a LUN second management table 60. As shown in FIG. 4, this data table group 51 also contains an LDEV management table 61 and a permission access type setting rule table 63.

As indicated in FIG. 3, the HP table 53 corresponds to such a table which is prepared for each of the host apparatus 5, 15, and 31. An HP table ID (identification information) and various sorts of communication information which are required for a communication operation based upon the iSCSI protocol are registered in this HP table 53. In these various sorts of communication information, for example, a host iSCSI name, an IP address, a TCP/IP option, an iSCSI option, a first iSCSI parameter, and a second iSCSI parameter are registered. Among the above-described information, the host iSCSI name, the IP address, the TCP/IP option, the iSCSI option and the first iSCSI parameter correspond to such information which is received from a host apparatus when this host apparatus issues a log-in request based upon the iSCSI protocol. The second iSCSI parameter corresponds to such information which is determined when a network address is judged (will be explained). As a consequence, the “host iSCSI name” corresponds to an iSCSI name which is allocated to a host apparatus (concretely speaking, iSCSI port of this host apparatus) of a log-in request source. The “IP address” corresponds to such an IP address which is allocated to a host apparatus (concretely speaking, iSCSI port of this host apparatus) of a log-in request source, or corresponds to such a global IP address which is allocated to a switching device (for instance, gateway) provided in a network to which this host apparatus is connected. The “TCP/IP option” corresponds to such information which contains, for example, TCP/IP protocol specific information, information as to whether or not DHCP (Dynamic Host Configuration Protocol) is used, and/or information as to whether or not DNS (Domain Name System) is used. The “iSCSI option” corresponds to such information which contains iSCSI protocol specific information, information as to whether or not CHAP (Challenge Handshake Authentication Protocol) is used, and/or a time out value. The “first iSCSI parameter” corresponds to such information which contains at least a total connection number, and iSCSI transfer length/transfer number. The “second iSCSI parameter” corresponds to such information which contains a permission access type. There are plural sorts as to the permission access types. For instance, these permission access types involve “RW” which implies that both a read operation and a write operation are permitted; “RO” which implies that only a read operation within the read operation and the write operation is permitted; and “RJT” (abbreviated word of “reject”) which implies that none of a read operation and a write operation is permitted.

Various sorts of information used to control accesses from host apparatus is stored in the host management table 57. Concretely speaking, HP table IDs, IP addresses, and permission access types, which correspond to the respective plural host iSCSI names, are in this host management table 57. Under initial condition, only the host iSCSI names have been registered in the host management table 57, and other information is brought into a blank condition. In such a case that an IP address received by the storage control system 3 when a log-in request is issued from the host apparatus 5, 15, or 31 to the storage control system 3 corresponds to a global IP address, there are some cases that the same IP addresses are set to the host management table 57 with respect to two, or more sorts of iSCSI names.

Such information that a designation of which LUN is accepted from which host apparatus 5, 15, or 31 is registered in the LUN first management table 59. Concretely speaking, for example, one, or more sets of LUNs corresponding to a plurality of iSCSI names (namely, a plurality of host apparatus) are registered in the LUN first management table 59. These LUNs may be previously prepared by a user under initially perfect condition. Alternatively, these LUNs may be edited by a user at proper timing.

Such information that which LUN corresponds to which LDEV# is registered in the LUN second management table 60. Concretely speaking, for instance, the LDEV# corresponding to the plural sorts of LUNs respectively have been registered in the LUN second management table 60.

As indicated in FIG. 4, information related to the respective LDEVs 35 is registered in the LDEV management table 61. Concretely speaking, for instance, LDEV#, starting addresses, data storage sizes, and the like, which correspond to the respective plural LDEVs 35, are registered in the LDEV management table 61.

Such information that which access type is allowed with respect to a log-in request source host when which IP address is received is registered in the permission access type setting rule table 63. Concretely speaking, for example, permission access types (for example, any one of “RW”, “RO”, and “RJT”) which correspond to the plural sorts of net masks respectively have been registered in the permission access type setting rule table 63.

It should be noted that a net mask is used in order to judge as to whether or not a log-in request source host belongs to which network based upon an IP address (will be referred to as “target IP address” hereinafter) of a log-in request side when a log-in request of a host apparatus is received, and another IP address (will be referred to as “own IP address” hereinafter) which has been stored in the iSCSI port 38 of the storage control system 3.

For instance, as represented in this drawing, when an IP address contains four numerals which are segmented by “.” (period), a net mask “255.255.255.0” implies that 3 beginning (left side) numerals in both a target IP address and the own IP address are identical to each other, and a 1 last numeral is different from the first-mentioned three numerals. In other words, this net mask implies that an internetwork distance is a small degree (for example, zero). That is to say, for instance, with respect to the small remote net connecting host 5 belonging to the small remote network 2 (see FIG. 1), “RW” is set as the permission access type.

Also, a net mask “255.255.0.0” implies that 2 beginning numerals in both a target IP address and the own IP address are identical to each other, and 2 remaining numerals are different from the first-mentioned two numerals. In other words, this net mask implies that an internetwork distance is a medium degree. That is to say, for instance, with respect to the medium remote net connecting host 15 belonging to the medium remote network 4 (see FIG. 1), “RO” is set as the permission access type.

Also, a net mask “255.0.0.0” implies that first 1 numeral in both the target IP address and the own IP address is the same, and 3 remaining numerals are different from the first-mentioned numeral. Also, a net mask “0.0.0.0.” implies that the same numerals are not completely present at the same places as to the target IP address and the own IP address. In other words, these two net masks “255.0.0.0” and “0.0.0.0” imply that internetwork distances are large degrees. That is to say, with respect to the large remote net connecting host 31 belonging to the large remote network 6 (see FIG. 1), “RJT” is set as the permission access type.

The above-described explanations are made as to the various sorts of tables contained in the data table group 51. It should also be noted that at least one table contained in the data table group 51 may be stored in any place other than the shared memory 47, for example, the physical disk group 39, or the local memory (for example nonvolatile memory) 123 of the iSCSI port 38.

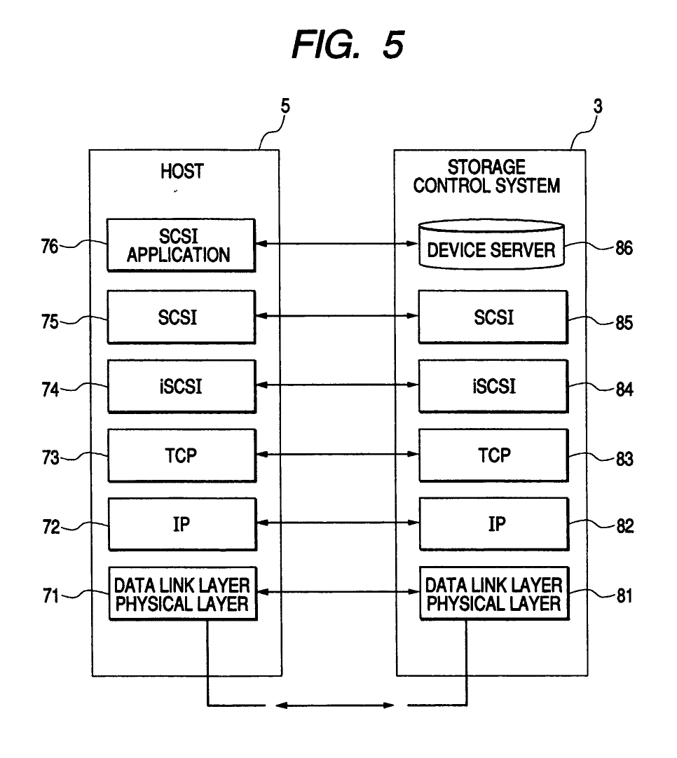

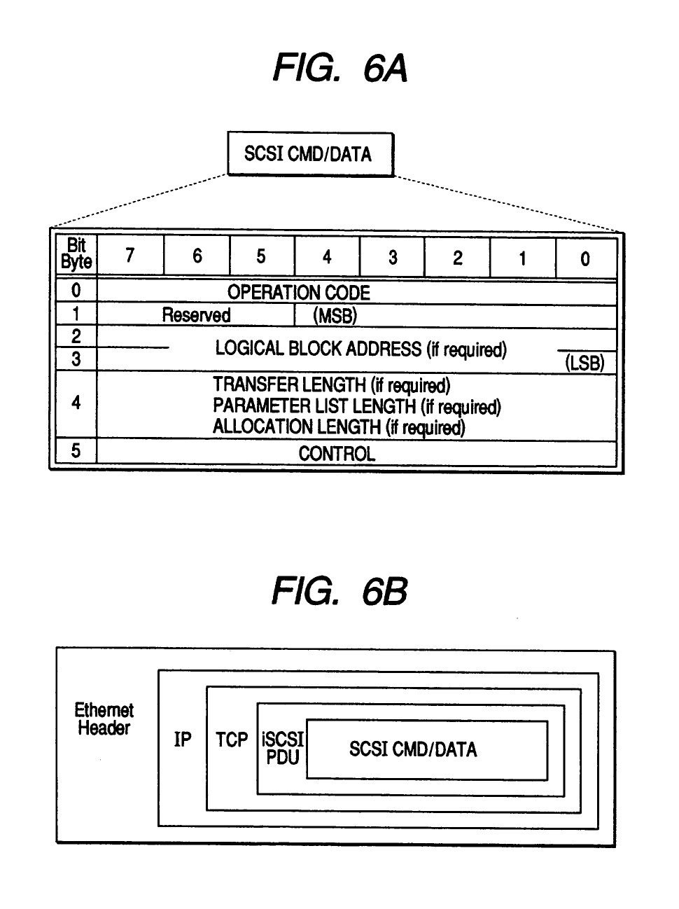

FIG. 5 illustratively shows a protocol construction used in a communication operation related to iSCSI. FIG. 6 represents structures of commands which are transmitted/received in this communication operation.

As shown in FIG. 5, in order to perform a communication operation based upon the iSCSI protocol, the host apparatus 5 (15, or 31) is provided with a physical layer and data link layer 71, an IP protocol layer 72, a TCP protocol layer 73, an iSCSI protocol layer 74, a SCSI protocol layer 75, and also, a SCSI application layer 76, which are sequentially ordered from a lower grade layer to an upper grade layer.

On the other hand, the storage control system 3 is provided with a physical layer and data link layer 81, IP protocol layer 82, a TCP protocol layer 83, an iSCSI protocol layer 84, a SCSI protocol layer 85, and also, a device server layer 86, which are sequentially order from a lower grade layer to an upper grade layer.

As exemplified in FIG. 6A, a command which is outputted from the SCSI application layer 76 of the host apparatus 5 via the SCSI protocol layer 75 corresponds to a command frame containing both a command and data (otherwise only command). Concretely speaking, this command frame is such a 6-byte command frame in which either a write operation code or a read operation code is contained in a head byte. Then, when this command frame is reached to the iSCSI protocol layer 74 and then is outputted from this iSCSI protocol layer 74 and from the data link layer/physical layer 71, this command frame becomes such an information frame as shown in FIG. 6B, namely becomes such an information frame that an SCSI command packet is enclosed by an ISCSIPDU unit, a TCP packet, an IP packet, and an Ethernet head packet. It should also be understood that symbol “PDU” is an abbreviated term of “Protocol Data Unit”, and this PDU contains a LUN which is designated by a host apparatus with respect to the storage control system 3, and a CDB (Command Descriptor Block).

Under the protocol structure shown in FIG. 5, both the data link layer/physical layers 71 and 81; both the IP protocol layers 72 and 82; the TCP protocol layers 73 and 83; the iSCSI protocol layers 74 and 84; both the SCSI protocol layers 75 and 85; both the SCSI application layer 76 and the device server layer 86 are successively brought into session, so that an I/O request outputted from the host apparatus is received by the storage control system 3, and this storage control system 3 executes a process operation based upon this I/O request.

For instance, under session condition between the data link layer and physical layer 71 and 81, since an ARP (Address Resolution Protocol) request is issued and an ARP response to this ARP request is made, MAC (Media Access Control) addresses of communication parties are acquired with each other. Under session condition between the IP protocol layers 72 and 82, since a “ping” request is issued and a “ping” response to this “ping” request is made, such a confirmation is carried out as to whether or not a counter party (IP address) is present. Concretely speaking, for example, the “ping” request is transmitted from a network (will be referred to as “target network” hereinafter) to which a log-in request source host has been connected to the storage control system 3. Also, under session condition between the TCP protocol layers 73 and 83, three packets for synchronizing the sequence numbers with each other are transmitted/received. Also under session condition between the iSCSI protocol layers 74 and 84, a connection of iSCSI is established by a log-in phase in which a log-in request is issued, and a log-in response to this log-in request is made (for example, IP address, iSCSI name of log-in request source host, and TCP port number are transmitted from target network to storage control system 3). Under session condition between the SCSI protocol layers 75 and 85, a SCSI command containing either a read request or a write request is transmitted from the host apparatus to the storage control system 3. Under session condition between the SCSI application layer 76 and the device server layer 86, write data is transmitted from the host apparatus to the storage control system 3, or the read data is transmitted from the storage control system 3 to the host apparatus.

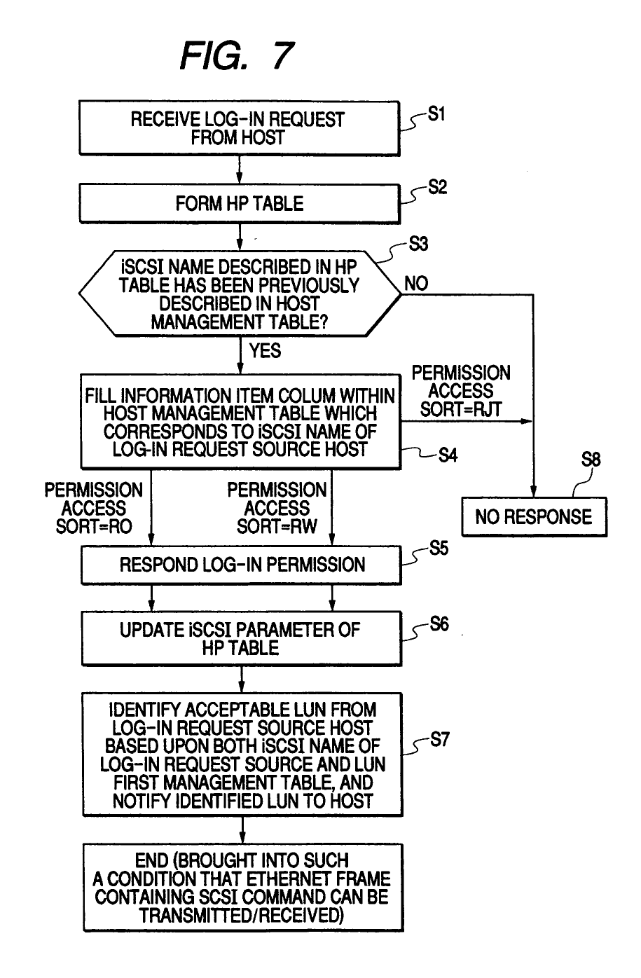

In this embodiment, the storage control system 3 controls an access (for example, either log-in request or access after this log-in) from a log-in request source host based upon the information received from the target network in the above-described log-in phase. Referring now to FIG. 7, a description is made of process flow operations for controlling an access from the log-in request source host, which is executed in the storage control system 3.

First, the protocol processing unit 122 of the iSCSI port 38 accepts a log-in request from a host 5, 15 or 33 (step S1). At the time of log-in request, the protocol processing unit 122 receives, for example, a TCP port number, an iSCSI name of a log-in request source host, and an IP address. This IP address corresponds to, for instance, an IP address of the log-in request source host, or a global IP address which is allocated to a switching device (for example, gateway) of the target network. All of the above-described information may be alternatively such information which has been entered by a user so as to be stored in a storage apparatus of a host apparatus, and then is read therefrom. Alternatively, all of the above-described information may be such information which has been acquired by the log-in request source host from a host management apparatus for managing one, or more sets of host apparatus belonging to the same network by DNS (Domain Name System).

In the step S1, when the iSCSI port 38 accepts the log-in request, the protocol processing unit 122 of the iSCSI port 38 performs a protocol processing operation (for instance, opening process operation of packet) with respect to this log-in request, and then transfers information (for example, TCP port number, iSCSI name of log-in request source host, IP address etc.) which has been obtained by this protocol process operation to a predetermined, or arbitrarily-selected channel processor 40. Also, the protocol processing unit 122 produces an HP table ID, and then transfers this HP table ID as well to the channel processor 40.

The channel processor 40 prepares a new HP table 53 (namely, new HP table 53 corresponding to log-in request source host) which owns the HP table ID received from the protocol processing unit 122. Then, the channel processor 40 writes the above-described host iSCSI name, IP address, TCP/IP option (at least a TCP port number, for example), iSCSI option, and first iSCSI parameter into the prepared HP table 53 based upon the information (for example, above-explained iSCSI name etc.) received from the protocol processing unit 122 (step S2).

Next, the channel processor 40 judges as to whether or not the host iSCSI name written in the new HP table 53 is made coincident with any one of the plural iSCSI names which have been previously registered in the host management table 57 (step S3) (this processing may be carried out before registering the host iSCSI name).

In such a case that a negative result is obtained (“N” in step S3) as a result of the judgement in this step S3, the channel processor 40 subsequently issues no response with respect to the log-in request source host (step S8). In other words, under the iSCSI protocol, the channel processor 40 may return any one of two sorts of log-in responses via the protocol processing unit 122 as a log-in response to the log-in request, while the two sorts of log-in responses contain both “log-in permission” which implies that a log-in is permitted, and “log-in refuse” which implies that a log-in is not permitted. However, in this embodiment, when the negative result is obtained in the step S3, the channel processor 40 never returns even such a “log-in refuse” (in this case, it is so designed that connection is cut due to time out). As one modification of this embodiment, while two sorts of response types, namely, “non response” and “return response of log-in refuse” are prepared as the response type as to the permission access type “RJT”, a response type may be alternatively selected based upon a type of a target network. In this modification, for example, when an internetwork distance is a first threshold or more and less than a second threshold of the internetwork distance (for example, middle degree), “log-in refuse” may be selected as the response type, whereas when this distance is the second threshold or more (for example, large degree), “non response” may be selected as the response type.

On the other hand, in such a case that a positive result is obtained as a result of the judgement in the step S3 (“Y” in step S3), the channel processor 40 fills an information item column within the host management table 57, which corresponds to an iSCSI name (will be referred to as “log-in iSCSI name” hereinafter) of the log-in request source host (step S4).

Concretely speaking, for example, the channel processor 40 writes the HP table ID of the new HP table 53 into an HP table ID column corresponding to the log-in iSCSI name.

Also, the channel processor 40 writes the IP address received from the protocol processing unit 122 of the iSCSI port 38 into an IP address column corresponding to the log-in iSCSI name.

Also, the channel processor 40 executes a network address judging operation in which the IP address is compared with the own IP address which is stored by the iSCSI port 38 which has received the log-in request by employing the permission access type setting rule table 63 (in particular, plural sorts of net mask recorded in this permission access type setting rule table 63). Then, the channel processor 40 selects an arbitrary permission access type from a plurality of permission access types based upon a result of this comparing operation, and then writes the selected permission access type into a permission access type column corresponding to the log-in iSCSI name.

In the step S4, when the permission access type corresponds to both “RO” and “RW”, the channel processor 40 notifies a log-in permission via the protocol processing unit 122 to the log-in request source host (step S5).

After the step S5, the channel processor 40 sets the above-explained selected permission access type as a second iSCSI parameter to the above-described new HP table 53 (step S6). Thereafter, the channel processor 40 acquires either one or a plurality of LUNs corresponding to the iSCSI name of the log-in request source from the LUN first management table 59, and then notifies the acquired one, or plural pieces of LUNs to the log-in request source host (step S7). Specifically, for example, the channel processor 40 receives a first inquiry command (for example, a ReportLUN command in accordance with the SCSI protocols) from the log-in request source host which received a log-in permission. The channel processor 40 responds to this inquire command, and specifies the HP table 53 in which are written an IP address and TCP port which are specified upon reception of the inquire command. The channel processor 40 then specifies a HP table ID allocated to the specified HP table 53, and specifies a host iSCSI name corresponding to the specified HP table ID with reference to the host management table 57. Thereafter the channel processor 40 specifies one or more LUNs related to the specified host iSCSI name with reference to the LUN first management table 59, and notifies the host, which is an issuing source of the inquiry command, of the specified one or more LUNs. Furthermore, thereafter, for example, when receiving a second inquiry command (for example, Inquiry command), the channel processor 40 returns an ID (for example, the name of the LU) for one or more LUNs corresponding respectively to the notified one or more LUs, and when receiving a third inquiry command (for example, Read Capacity command), the channel processor 40 can provide a notification of the size (storage capacity) or the like for one or more LUs corresponding respectively to the notified one or more LUs.

As a result of carrying out S7, the log-in phase is ended. Subsequently, the Ethernet frame (see FIG. 6B) which contains the SCSI command may be received. In other words, as a result of carrying out S7, the log-in request source host receives notifications of one or more LUNs and recognizes them, and thereafter can transmit an I/O request corresponding to any LUN of the recognized one or more LUNs.

It should also be noted that when the permission access type corresponds to “RJT” in the step S4, the channel processor 40 makes no response with respect to the log-in request source host (step S8).

Since a series of the above-described process flow operations are carried out, the permission access types which have been set every host apparatus 5, 15, and 31 are registered to the host management table 57, and thus, the log-in phase is ended. The above-described series of process operations is carried out every time when a log-in request is received, such as when a log-in request is received again after a logging in and then logging out, or when a log-in is required again due to an error occurred in the I/O processing after the log-in.

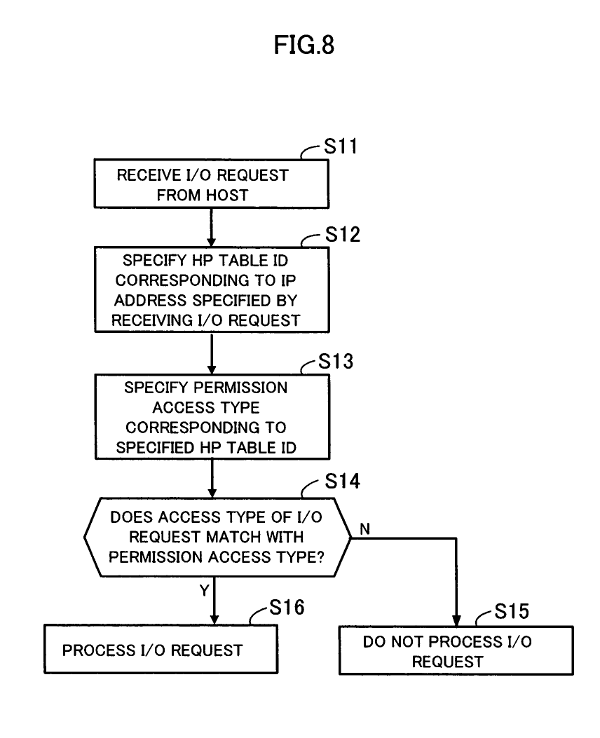

After the log-in, for example, an access control operation is carried out in the process flow exemplified in FIG. 8.

The channel processor 40 receives an I/O request (Ethernet frame) containing an LUN from a host apparatus via the iSCSI port 38 (S11).

The channel processor 40 specifies a HP table ID corresponding to an IP address and TCP port number of the I/O request issuing source host specified by receiving an I/O request (i.e. received via a protocol processing unit 122) with reference to the host management table 57 (Sl2). Here, the channel processor 40 may specify a HP table ID from the HP table 53 in which an IP address and TCP port number of the I/O request issuing source host are written.

The channel processor 40 specifies a permission access type corresponding to the HP table ID specified in S12 with reference to the host management table 57 (Sl3). Here, the channel processor 40 may specify a permission access type corresponding to the HP table ID specified in S12 based on the second iSCSI parameter (parameter containing the permission access types) of the HP table 53 which has the HP table ID specified in S12.

The channel processor 40 compares the access type of the I/O request received in S11 with the permission access type specified in S13, and judges whether or not the access type of the I/O request matches with the above permission access type (S14). Here, for example, when the I/O request is a write request or a read request (for example, when “write (e.g. “OA”)” or “read (e.g. “08”)” is written in OPERATIONCODE which is positioned in a head byte of SCSI command shown in FIG. 6(A)), and the permission access type is “RW”, the channel processor 40 judges that the access type of the I/O request matches with the permission access type, since the permission access type “RW” permits both the write request and read request. On the other hand, for example, when the I/O request is a write request and the permission access type is “RO”, the channel processor 40 judges that the access type of the I/O request does not match with the permission access request, since the permission access request “RO” permits only the read request but not the write request. When the channel processor 40 does not judge that the access type of the I/O request matches with the permission access request (N in S14), the channel processor 40 does not carry out the processing of the I/O request (For example, response as an error) (S15). More specifically, for example, the channel processor 40 returns the received I/O request or follows the SCSI protocol in accordance with the check condition response.

When the channel processor 40 judges that the access type of the I/O request matches with the permission access request (Y in S14), the channel processor 40 carries out the processing of the I/O request (S16).

Specifically, for example, the channel process 40 can acquire LDEV# corresponding to the LUN contained in the I/O request from the LUN second management table 60, and instruct a predetermined disk processor to read, or write data with respect to such an LDEV corresponding to the acquired LDEV#.

The above-described process operations are explanations as to this embodiment. It should also be understood that in this embodiment, for instance, both the process operation explained with reference to FIG. 7, and the access control process operation executed after the permission access type has been set may be alternatively carried out by any structural element other than the channel processor 40, for example, by the protocol processing unit 122 of the iSCSI port 38. Alternatively, in this embodiment, for example, at least one of the IP address and the iSCSI name may be set specifically with respect to the storage control system 3, or may be set specifically with respect to each of the iSCSI ports 38.

According to the above-described embodiments, a log-in is not permitted unless the log-in is carried out from the host having a host iSCSI name that matches with the host iSCSI name registered in the storage control system 3 in advance. Accordingly, a log-in from an unreliable host can be prevented.

Further, as previously described, in accordance with the above-described embodiment, the permission address type is set as a result of the comparison between the IP address of the log-in request source host and the own IP address, namely, based upon the above-described internetwork distance. In other words, based upon such a condition that a communication network to which a log-in request source host belongs is located at a which place (namely, how long this place is separated from the communication network 2 covering the storage control system 3), an address type is determined which is executed by this log-in request source host. In other words, the levels of the respective communication networks 2, 4, and 6 are classified in response to the internetwork distances of the respective communication networks 2, 4, and 6, while the communication network 2 containing the storage control system 3 is defined as the reference. Then, the permission access types are determined based upon the respective classified levels. As a result, the access control operation can be carried out in the unit of the communication network.

Also, in accordance with the above-explained embodiment, the storage control system 3 returns no response with respect to such an access operation made by a host apparatus belonging to a communication network from which a illegal access may be possibly issued. As a consequence, since existence of the storage control system 3 is not notified with respect to this host apparatus, higher security can be secured.

Incidentally, based on the above-described embodiment, the following modified examples are possible. It should be noted that the descriptions below mainly explain the differences with the above-described embodiment, thus explanations about the similarities with the above-described embodiment are omitted or simplified.

### (1) FIRST MODIFIED EXAMPLE

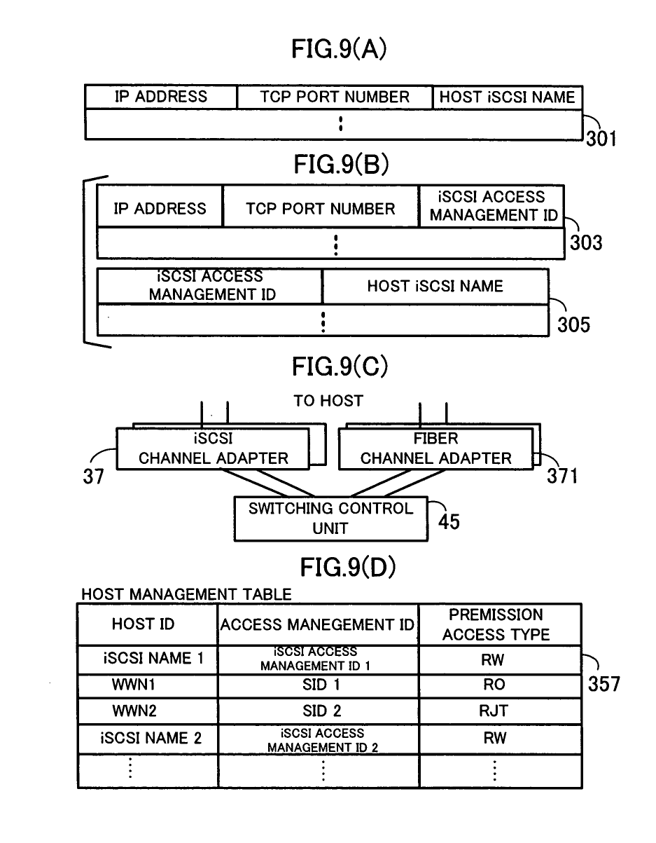

In a first modified example, as exemplified in FIG. 9(A), a first table 301 is prepared in a predetermined storage area (for example, the shared memory 47), and an IP address and TCP port number, and a host iSCSI name are related to the first table 301. Specifically, for example, when matching with a host iSCSI name in which a host iSCSI name received at the time of the log-in is registered beforehand, the channel processor 40 can relate the host iSCSI name received at the time of the log-in to the IP address and TCP port number specified at the time of the log-in, on the first table 301. In this case, thereafter, if an IP address and TCP port number are specified by an access from the host, the channel processor 40 can specify a host iSCSI name corresponding to the IP address and TCP port number from the first table 301. The first table 301 may be the host management table 57 in which the permission access type is registered for each host iSCSI name.

According to the first modified example, it is not necessary to generate a management ID (referred to as “iSCSI access management ID” hereinbelow) in the iSCSI protocol such as the HP table ID. In this case, for example, if the channel processor 40 manages the permission access type for each host iSCSI name, the channel processor 40 does not have to prepare the HP table 53.

### (2) SECOND MODIFIED EXAMPLE

In the second modified example, the HP table 53 does not have to be created. If not created, the above-described iSCSI access management ID as an alternative to the HP id table can be issued by the channel processor 40 or a different apparatus. For example, as exemplified in FIG. 9(B), an issued iSCSI access management ID can be related to an IP address and TCP port number on a second table 303 which is prepared in a predetermined storage area (for example, the shared memory 47) by the channel processor 40. Further, the iSCSI access management ID can be related to a host iSCSI name on a third table 305 (may be the host management table 57) which is prepared in a predetermined storage area (for example, the shared memory 47) by the channel processor 40.

In the second modified example, as exemplified in FIG. 9(C), when a fiber channel adapter 371 for performing control based on the protocol of the channel adapter, and an iSCSI channel adapter 37 (i.e. the channel adapter explained with reference to FIG. 2 and the like) for performing control based on the iSCSI protocol are mixed in the same storage control system, accesses based on the separate protocols can be controlled using the same table.

A host management table 357 exemplified in FIG. 9(D) is prepared as the same table. A host ID, access management ID, and a set of permission access types can be registered in the host management table 357 for each host. The host ID can be WWN in the case of the fiber channel protocol, and can be iSCSI name in the case of the iSCSI protocol. The access management ID can be SID (Source IDentifier) in the case of the fiber channel protocol, and can be an iSCSI access management ID (for example, HP table ID) in the case of the iSCSI protocol.

It is possible to control accesses in accordance with different protocols by using the table 357.

Specifically, for example, when the iSCSI channel adapter sets 37 receive a log-in request, the iSCSI channel adapter 37 can perform the above-describe processing, register an iSCSI name as a host ID in the host management table 357, register an iSCSI access management ID as an access management ID, and register a permission access type. Thereafter, for example, when the iSCSI channel adapter sets 37 receive an I/O request, the iSCSI channel adopter sets 37 can control whether or not to process the I/O request (i.e. whether or not to permit an access) by specifying an iSCSI access management ID (or a host iSCSI name) from the IP address and TCP port number and also specifying a permission access type corresponding to the specified iSCSI access management ID from the host management table.

On the other hand, for example, when the fiber channel adopter 371 receives a log-in request, the fiber channel adapter 371 can specify a WWN of the log-in request source, generate n SID, register the WWN as the host ID in the host management table 357, register the abovementioned generated SID as an access management ID, and register a permission access type discriminated in a specified processing. Thereafter, for example, when the fiber channel adapter 371 receives an I/O request, the fiber channel adapter 371 controls whether or not to process the I/O request (i.e. whether or not to permit an access) by specifying an SID and also specifying a permission access type corresponding to the specified SID.

As above, in the second modified example, other types of iSCSI access management ID can be employed instead of the HP table ID. Further, in the second modified example, it is possible to control accesses in accordance with different protocols by using the same table.

### (3) THIRD MODIFIED EXAMPLE

In the above-described embodiment, the permission access types are differentiated on the basis of the length of the internetwork distance. However, in the third modified example, the permission access types are controlled on the basis of the length of the distance between the storage control system 3 and the host (“system-host distance” hereinbelow), instead of (or in addition to) the length of the internetwork distance.

The system-host distance can be expressed in the number of the intervening devices that are present between the host and the storage control system 3 (particularly, for example, the number of intervening devices of a predetermined type). If the network composition is known in advance, for example, the number of the intervening devices may be registered in a predetermined storage area (for example, the shared memory 47) of the storage controls system 3 on the basis of the abovementioned network composition.

In the third modified example, the system-host distance can be expressed by using a difference value between a TTL when “ping” transmitted from the storage control system 3 (“TTL-in-transmission” hereinbelow) and a TTL responded from the host (TTL at the time of reception in the host, or “TTL-in-reception” hereinbelow), and the permission access types can be differentiated for each host on the basis of the difference value.

It should be noted that “TTL” is an abbreviation of “Time To Live”, and is a value expressing a validity period of a packet. TTL is included in the packet and “ping” transmitted by an ICMP (Internet Control Message Protocol), and is reduced one every time the packet goes through a specified type of intervening device (for example, router and the like). A channel adapter (for example, a channel processor) can transit the packet containing the TTL. Every time the packe] goes through a specified type of intervening device, the TTL-in-transmission contained in the packet is reduced one by the intervening device and received by the host. The TTL in the packet when it is received by the host (i.e. TTL-in-reception) becomes a TTL-in-transmission-N when, for example, the packet goes through the N number (N is an integer that is zero or above) of specified type of intervening devices. If N is an integer less than the TTL-in-transmission, the reduced TTL-in-transmission reaches the host, and, as a response to the “ping” transmission of the packet containing the TTL-in-transmission, the channel adapter can receive this reduced TTL-in-transmission (i.e. TTL-in-reception) from the host. However, when N is an integer of TTL-in-transmission or above, the reduced TTL-in-transmission becomes “0” before reaching the host, the packet containing the TTL which has become “0” is discarded before reaching the host, and thus does not reach the host. In this case, for example, the channel adapter, which has received the packet containing TTL, can transmit this packet, and, when not receiving a response even after a lapse of a certain period of time, transmit to the host a packet containing a new TTL-in-transmission having a value which is larger than the above TTL-in-transmission by a predetermined value, and wait for a response again.

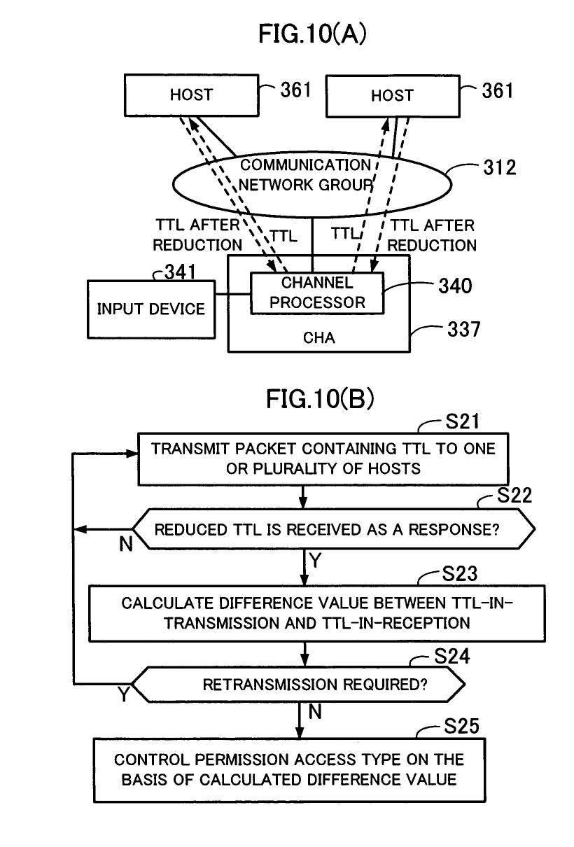

FIG. 10(A) is a block diagram for explaining a process carried out in the third modified example. FIG. 10(B) is a figure showing an example of a flow of a process carried out by the channel processor 40 in the third modified example. Hereinafter, the processes carried out in the third modified example are explained with reference to both figures.

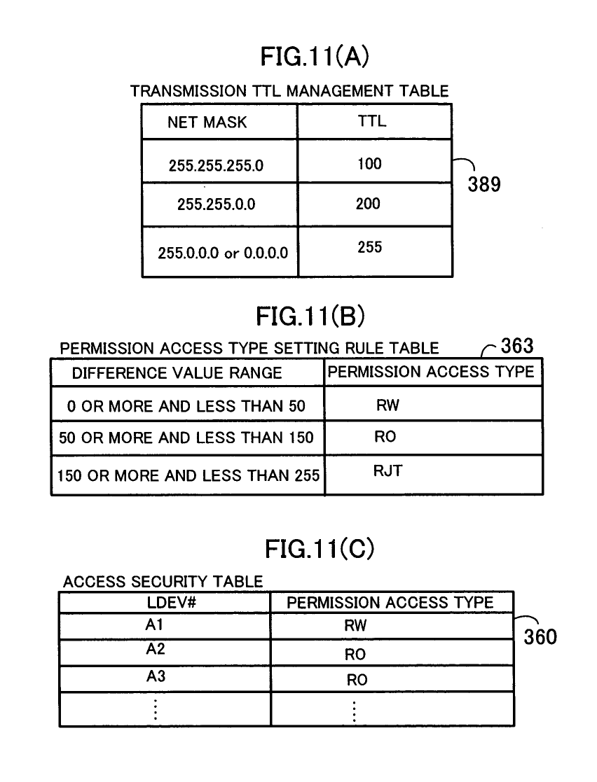

A channel processor 340 transmits a packet containing TTL-in-transmission to one or a plurality of hosts 361 via a communication network group 312 (S21). The communication network group 312 comprises at least one of the communication networks 2, 4 and 6 described with reference to FIG. 1. Therefore, the plurality of hosts 361, 316 may be connected to the same communication network or a different type of communication network. When the channel processor 340, for example, specifies an IP address of the specified host and transmits a “ping” request (a process to check whether or not the specified IP address exists), the channel processor 40 can transmit a packet containing a TTL-in-transmission. The TTL-in-transmission may be a value specified from an input device 341 (for example, a maintenance terminal realized by a notebook computer), or may be automatically determined based on a predetermined rule. For example, a channel processor can refer to a transmission TTL management table (a table in which a net mask and TTL are related to each other) 389 exemplified in FIG. 11(A), and employ a TTL, which corresponds to a net mask specified based on a comparison between the IP address of the host and the own IP address, as the TTL-in-transmission.

Thereafter, when not receiving a response from the transmission destination host of the packet containing the TTL-in-transmission even after a lapse of a certain period of time (N in S22), the channel processor 340 can retransmit the packet containing the TTL-in-transmission to the transmission destination host which does not respond (S21). It should be noted at this time that the channel processor 340 may transmit a packet containing a new TTL-in-transmission having a value which is larger than the TTL-in-transmission, which has been transmitted immediately before, by a predetermined value, to the transmission destination host which does not respond.

When the channel processor 340 receives a response (containing a TTL-in-reception) from the transmission destination host of the packet containing the TTL-in-transmission within a certain period of time (Y in S22), the channel processor 340 calculates a difference value between the TTL-in-transmission and the TTL-in-reception (S23).

If the channel processor 340 needs to retransmit the packet containing the TTL-in-transmission (Y in S24), the channel processor 340 transmits this packet to al or some of the transmission destination hosts in S21 (S21). When it is not necessary to retransmit the packet (N in S24), the channel processor 340 uses the difference value calculated in S23 as a base to determine a permission access type corresponding to the transmission destination type (S25).

Specifically, for example, the channel processor 340 carries out the steps S21 to S23 more than once for any hosts in order to improve the accuracy of the difference value obtained in S23, whereby the channel processor 340 can acquire a plurality of difference values for the respective host, and calculate an average value of the plurality of difference values, and this calculated average value can be taken as a difference value to be used to determine a permission access type.

Further, for example, the channel processor 340 refers to a permission access type setting rule table shown in FIG. 11(B) (table in which a permission access type is related to each difference value range) 363, whereby the channel processor 340 can specify a permission access type that falls into a difference value range to which the difference value obtained in S23 belongs (for example, if the difference value is 50, it belongs to a difference value range of 50 or more and less than 150, thus “RO” is specified) and relate the specified permission access type to the iSCSI name of the host corresponding to the difference value obtained in S23.

Furthermore, for example, in S25 the channel processor 340 compares a difference value (or the abovementioned average value) of a first host with a difference value (or the abovementioned average value) of a second host, and can differentiate the permission access types for the first and second host respectively on the basis of a result of the comparison (in other words, differentiate the permission access types for the respective hosts on the basis of a relative positions of a plurality of hosts which are discriminated from the difference values). For example, if the difference value of the first host is smaller than the difference value of the second host, the first host is placed closer to the channel processor 340, thus the channel processor 340 can set a permission access type of higher level for the first host than the second host (for example, if “RO” is set for the second host, “RW” can be set for the first host).

The above is the specific example of the third modified example.

It should be noted that in the third embodiment the permission access type may be determined based on the TTL-in-reception itself instead of the difference value between the TTL-in-transmission and TTL-in-reception. Specifically, for example, if the TTL-in-reception is a first threshold or more of the TTL, “RW” is set, and if the TTL-in-reception is less than the first threshold and the second threshold or more, “RO” may be set. Sine the TTL-in-transmission can be changed on the transmitting side, in the case where the permission access type is determined based on the TTL-in-reception itself, by changing the TTL-in-transmission in the packet to be transmitted to a host, the permission access type for the host can be changed.

Moreover, in the third modified example, the channel processor may differentiate the permission access type to the transmission destination host in accordance with the case when receiving the TTL-in-reception and the case when not receiving the TTL-in-reception (for example, a response of “unreachable” is made). For example, when receiving the TTL-in-reception, the channel processor may determine a permission access type based on the TTL-in-reception, and when not receiving the TTL-in-reception, the channel processor may certainly set “REJ” (or nor response) as the permission access type.

### (4) FOURTH MODIFIED EXAMPLE

In the fourth modified example, as exemplified in FIG. 11(c), an access security table 360 is prepared in a predetermined storage area (for example, the shared memory 47). The access security table 360 is related to a permission access type for each LDEV (or each LUN).

In the fourth modified example, a permission access type related to a host iSCSI name is preferentially employed, and access control can be performed for each LDEV as long as consistent with the permission access type.

Specifically, for example, when the access type of an I/O request issued from a host matches with the permission access type related to the host, the channel processor specifies the access type of a LDEV# belonging to a LUN contained in the I/O request. When the access type of the I/O request matches with the access type of the LDEV#, the channel processor processes the I/O request, and, when not matching, does not process the I/O request (for example, makes an error response). More specifically, for example, when the channel processor receives a write request from a host and the permission access type related to the host is “RW”, the channel processor specifies an access type of a LDEV# which is specified based on the write request, and, when the specified access type is “RO”, does not perform writing of the data in accordance with the write request (for example, makes an error response by a check condition in accordance with the SCSI protocols), since it is not possible. Further, for example, when the channel processor receives a read request from a host and the permission access type related to the host is “RW”, and further when the channel processor specifies an access type of the LDEV# specified based on the read request and the specified access type is “RO”, the channel processor reads out the data from the LDEV corresponding to the LDEV#, and returns the read out data to the host, since read out is also permitted.

While the preferred embodiments and some modified examples of the present invention have been described in detail, these are made so as to merely exemplify the explanations of the present invention, and therefore, the technical scope of the present invention is not limited only to these embodiments and the modification. The present invention may be alternatively realized by way of other embodiments. For example, the inventive idea of the present invention may be applied not only to the communication environment based upon the iSCSI protocol, but also the various environments under which an access is received via either one or a plurality of communication networks. Also, for instance, such a table is prepared and this table defines such a corresponding relationship that which response is returned with respect to not only a read command and a write command, but also other sorts of SCSI command codes (abstractly speaking, access type). In the case that a SCSI command is received after a log-in request is issued, a content of a response may be alternatively selected based upon this table and a SCSI command code of this received SCSI command. Further, for example, an iSCSI name or iSCSI access management ID (for example, HP table ID) may be specified not only from the set of IP address and TCP port number, but also from information elements of either one of them or of other types.

1. A storage control system, comprising:
a control apparatus which receives from a host apparatus an iSCSI name and a log-in request of the host apparatus via one or plurality of communication networks; and
one or more storage apparatuses which can be an access destination of the host apparatus, and
a storage resource in which one or plurality of iSCSI names are stored beforehand,
wherein the control apparatus refers to the storage resource, judges whether or not the received iSCSI name matches with any of the one or plurality of iSCSI names registered beforehand, permits a log-in to the host apparatus when a positive judgment result is obtained, and does not permit a log-in to the host apparatus when a negative judgment result is obtained, in accordance with the received log-in request.

2. The storage control system according to claim 1, wherein, before receiving an access from the host apparatus to which a log-in is permitted, the control apparatus prepares a management table for controlling an access from the host apparatus, and a table ID for identifying the management table, and relates the table ID, a host information element related to the host apparatus, and the iSCSI name of the host apparatus to each other, and, when receiving an access request from the host apparatus to which a log-in is permitted, the control apparatus specifies a table ID corresponding to the host information element of the host apparatus, and controls the access by using the management table identified based on the specified ID table.

3. The storage control system according to claim 1, wherein the control apparatus:
determines a permission access type to be permitted for the host apparatus to which a log-in is permitted;
relates the determined permission access type to the iSCSI name of the host apparatus on the storage resource;
relates the iSCSI name of the host apparatus to the host information element related to the host apparatus;
when receiving an access request from the host apparatus to which a log-in is permitted, the control apparatus specifies an iSCSI name corresponding to the host information element of the host apparatus, specifies a permission access type corresponding to the specified iSCSI name, and judges whether or not the access type of the access request matches with the specified permission access type, and, when a positive judgment result is obtained, executes the processing in accordance with the access request.

4. The storage control system according to claim 1, wherein the storage resource is related to a sub-permission access type for each access destination of the storage apparatus which is accessed in accordance with an access request, and when the positive judgment result is obtained, the control apparatus specifies the sub-permission access type corresponding to an access destination in accordance with the access request from the storage resource, and judges whether or not the access type of the access request matches with the specified sub-permission access type, and, when a positive judgment result is obtained, executes the processing in accordance with the access request.

5. The storage control system according to claim 1, wherein:
the control apparatus determines a permission access type to be permitted for the host apparatus to which a log-in is permitted, on the basis of a system-host distance between the storage control system and the host apparatus; and
when receiving an access request from the host apparatus to which a log-in is permitted, the control apparatus judges whether or not an access type of the access request matches with the permission access type, and, when a positive judgment result is obtained, executes the processing in accordance with the access request.

6. The storage control system according to claim 5, wherein the control apparatus transmits a TTL to the host apparatus to which a log-in is permitted, receives a reception TTL value, which is a value expressed by the TTL received by the host apparatus, from the host apparatus, and determines the permission access type on the basis of a difference value between the value expressed by the transmitted TTL and the reception TTL value or on the reception TTL value itself.

7. The storage control system according to claim 1, wherein in the storage resource, a storage apparatus ID that is allowed to recognize the host apparatus that can be identified from iSCSI names is related to one or a plurality of iSCSI names, and the control apparatus specifies a storage apparatus ID corresponding to the iSCSI name of the host apparatus to which a log-in is permitted by referring to the storage resource, and notifies the host apparatus to which a log-in is permitted of the specified storage apparatus ID.

8. A storage control method which can be realized by a storage control system comprising one or more storage apparatuses which can be an access destination of a host apparatus, wherein
an iSCSI name and a log-in request of the host apparatus are received from the host via one or plurality of communication networks;
a storage resource in which one or plurality of iSCSI names are stored beforehand is referred, it is judged whether or not the received iSCSI name matches with the one or any one of the iSCSI names registered beforehand, and
when a positive judgment result is obtained, a log-in to the host apparatus is permitted according to the received log-in request.

9. The storage control method according to claim 8, comprising the steps of, before receiving an access from the host apparatus to which a log-in is permitted, preparing a management table for controlling an access from the host apparatus, and a table ID for identifying the management table, relating the table ID, a host information element related to the host apparatus, and the iSCSI name of the host apparatus to each other, and, when an access request is received from the host apparatus to which a log-in is permitted, specifying a table ID corresponding to the host information element of the host apparatus, and controlling the access by using the management table identified based on the specified ID table.

10. The storage control method according to claim 8, comprising the steps of:
determining a permission access type to be permitted for the host apparatus to which a log-in is permitted;
relating the determined permission access type to the iSCSI name of the host apparatus on the storage resource;
relating the iSCSI name of the host apparatus to the host information element related to the host apparatus on the storage resource;
when an access request is received from the host apparatus to which a log-in is permitted, specifying an iSCSI name corresponding to the host information element of the host apparatus, specifying a permission access type corresponding to the specified iSCSI name, and judging whether or not the access type of the access request matches with the specified permission access type, and, when a positive judgment result is obtained, executing the processing in accordance with the access request.

11. The storage control method according to claim 10, comprising the steps of:
relating the storage resource to a sub-permission access type for each access destination of the storage apparatus which can be accessed in accordance with an access request;
when the positive judgment result is obtained, specifying the sub-permission access type corresponding to an access destination in accordance with the access request from the storage resource, and judging whether or not the access type of the access request matches with the specified sub-permission access type; and,
when a positive judgment result is obtained, executing the processing in accordance with the access request.

12. The storage control method according to claim 8, comprising the steps of:
determining a permission access type to be permitted for the host apparatus to which a log-in is permitted, on the basis of a system-host distance between the storage control system and the host apparatus; and
when receiving an access request from the host apparatus to which a log-in is permitted, judging whether or not an access type of the access request matches with the permission access type, and, when a positive judgment result is obtained, executing the processing in accordance with the access request.

13. The storage control method according to claim 12, wherein a TTL is transmitted to the host apparatus to which a log-in is permitted, a reception TTL value, which is a value expressed by the TTL received by the host apparatus, is received from the host apparatus, and the permission access type is determined on the basis of a difference value between the value expressed by the transmitted TTL and the reception TTL value or on the reception TTL value itself.

14. The storage control method according to claim 8, wherein in the storage resource, a storage apparatus ID that is allowed to recognize the host apparatus that can be identified from iSCSI names is related to one or a plurality of iSCSI names, and a storage apparatus ID, which corresponds to the iSCSI name of the host apparatus to which a log-in is permitted, is specified by referring to the storage resource, and the host apparatus to which a log-in is permitted is notified of the specified storage apparatus ID.
